(19) United States
(12) Patent Application Publication
(10) Pub. No.: US 2022/0055052 A1
(43) Pub. Date: Feb. 24, 2022

(54) DISPENSER

(71) Applicant: Kao Corporation, Tpkyo (JP)

(72) Inventor: Kazuyuki UEHARA, Moka-shi (JP)

(73) Assignee: Kao Corporation, Tokyo (JP)

(21) Appl. No.: 17/428,718

(22) PCT Filed: Feb. 5, 2020
(86) PCT No.: PCT/JP2020/004286

§ 371 Date: Aug. 5, 2021

(30) Foreign Application Priority Data
Feb. 8, 2019 (JP) 2019-021535

(51) Int. Cl. B05B 11/00

(52) U.S. Cl. CPC B05B 11/3032; B05B 11/309; B05B 11/3014

(57) ABSTRACT

A dispenser capable of discharging a liquid material from a discharging opening includes a pump chamber capable of sucking the liquid material; a first communication port as an outlet provided in the pump chamber; and a first passage as a pathway provided to make the first communication port and the discharging opening communicable with each other and allowing the flow of the liquid material. The first communication port is positioned on the opposite side to the discharging opening across a central axis of the pump chamber.

### TECHNICAL FIELD

The present invention relates to a dispenser.

### BACKGROUND ART

Conventionally, dispensers capable of discharging a liquid material from a discharging opening are known. For example, a dispensing assembly disclosed in Patent Literature 1 dispenses a fluid product in the form of a liquid or a paste. The dispensing assembly includes a container holding a product to be dispensed and a dispensing head connected to the container. The dispensing head has a dispensing channel connected to the outside. A terminal portion of the dispensing channel is opened to the outside. The other end portion of the dispensing channel is in contact with a variable volume chamber. The variable volume chamber is separated from the outside by a dome having a flexible diaphragm.

### CITATION LIST

### Patent Literature

Patent Literature 1: U.S. Pat. No. 5,492,252 A

### SUMMARY OF INVENTION

The present invention relates to a dispenser capable of discharging a liquid material from a discharging opening. The dispenser of the present invention includes a pump chamber capable of sucking a liquid material, an outlet provided in the pump chamber, and a pathway provided to make the outlet and the discharging opening communicable with each other and allowing the flow of the liquid material. The outlet is positioned on the opposite side to the discharging opening across the central axis of the pump chamber.

### BRIEF DESCRIPTION OF DRAWINGS

FIG. 1 is a perspective view of a dispenser according to a first embodiment of the present invention.

FIG. 2 is a cross-sectional view (equivalent to a view along the II-II line of FIG. 3) of the dispenser according to the same embodiment.

FIG. 3 is a cross-sectional view (equivalent to a view along the III-III line of FIG. 2) of the dispenser according to the same embodiment.

FIG. 4 is a perspective view of a dispenser body according to the same embodiment.

FIG. 5 is a top view of the dispenser body according to the same embodiment.

FIG. 6 is a cross-sectional view in an initial state for illustrating the action of the dispenser according to the same embodiment.

FIG. 7 is a cross-sectional view in a maximum stroke state for illustrating the action of the dispenser according to the same embodiment.

FIG. 8 is a cross-sectional view of a modification of the dispenser according to the same embodiment.

FIG. 9 is a partial cross-sectional view of a dispenser according to a second embodiment of the present invention.

FIG. 10 is a partial cross-sectional view for illustrating the action of the dispenser according to the same embodiment.

### DESCRIPTION OF EMBODIMENTS

In the dispensing head described in Patent Literature 1, the other end portion of the dispensing channel in contact with the variable volume chamber and the terminal portion of the dispensing channel opened to the outside of the dispensing channel are positioned on the same side with respect to the central axis of the variable volume chamber. Thus, when the dispensing assembly is tilted such that the terminal portion of the dispensing channel opened to the outside of the dispensing channel is relatively positioned on the vertically lower side in the use of the dispensing assembly, the remaining air is positioned on the vertically upper side in a compression chamber, whereas the other end portion of the dispensing channel in contact with the variable volume chamber is positioned on the vertically lower side as with the above-described terminal portion of the dispensing channel. This makes it difficult to allow the air in the variable volume chamber to escape from the above-described other end portion of the dispensing channel through the dispensing channel, i.e., air release. Thus, the conventional technique has been desired to improve the air releasability from the pump chamber. Hence, the present invention relates to a dispenser capable of improving the air releasability.

Hereinafter, suitable embodiments of the present invention are described in detail with reference to the accompanying drawings. In the present description and drawings, duplicate descriptions are omitted by attaching the same signs to constituent components having substantially the same functional configurations.

### First Embodiment

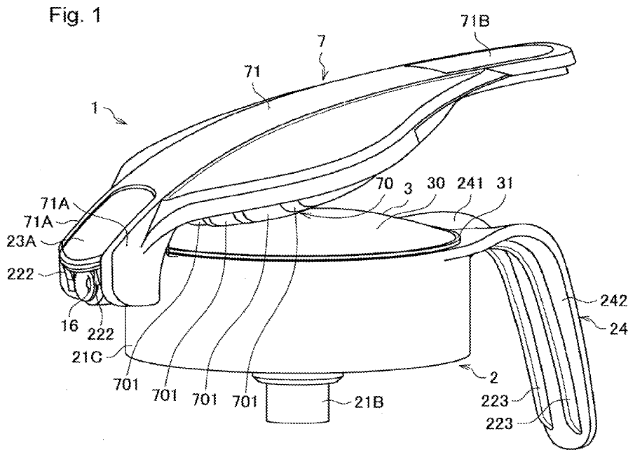

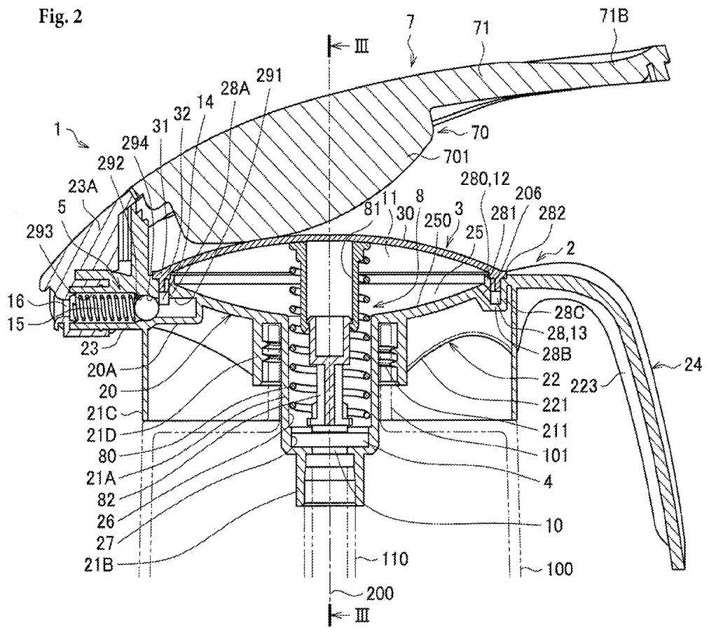

First, the configuration is described. FIGS. 1 to 3 illustrate the configuration of a dispenser 1 of this embodiment before action (initial state). The dispenser 1 is a device capable of discharging a liquid material from a discharging opening 16 in response to a user's operation. The liquid material includes a paste and may be, for example, a liquid detergent, fabric softener, bleach, shampoo, rinse, conditioner, body soap, cosmetic liquid, pharmaceutical drug, liquid seasoning, or the like. The dispenser 1 is a so-called pump dispenser and has a suction port 10, a pump chamber 11, and the discharging opening 16 as illustrated in FIG. 2. The dispenser 1 may discharge the liquid material as it is or may be provided with a mechanism for atomizing the liquid material and discharge the liquid material in an atomized form.

The liquid material can be contained in a container 100 separate from the dispenser 1. The container 100 has a bottle shape, for example, and is mounted to the dispenser 1 to supply the liquid material to the dispenser 1. The dispenser 1 and the container 100 mounted to each other function as a discharge container. Depending on the form of the container 100, a suction pipe 110 may be connected to the suction port 10 of the dispenser 1. When a so-called delamination container including an inner layer contracting with a reduction in the liquid material contained in the delamination container is used as the container 100, the suction pipe 110 may not be connected to the dispenser 1.

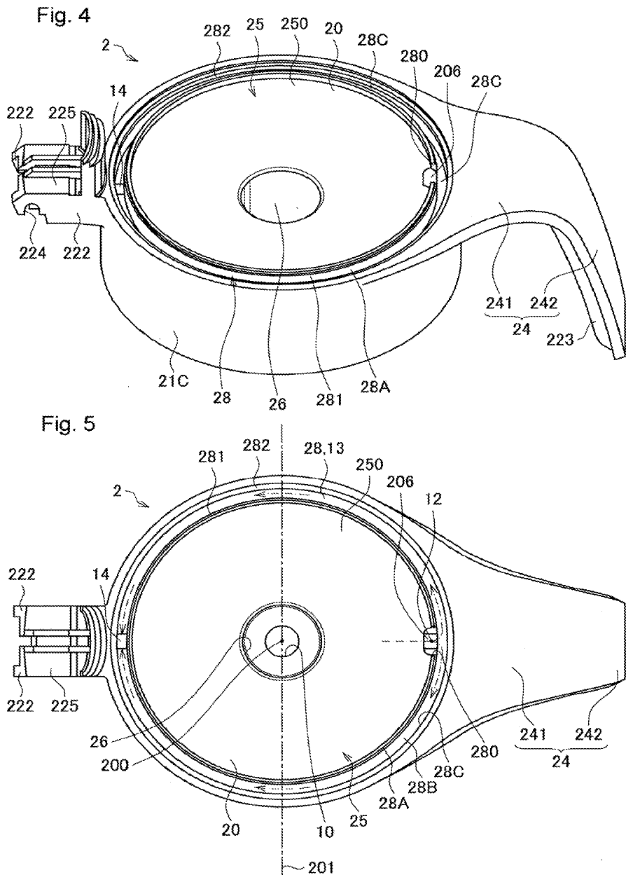

The dispenser 1 includes a dispenser body 2, an elastic member 3, a suction valve 4, a discharge valve 5, a pressing member 7, and a biasing unit 8. FIGS. 4 and 5 illustrate the configuration of the dispenser body 2.

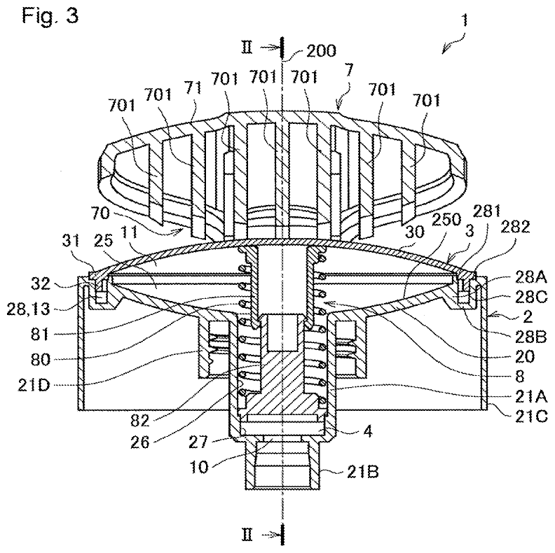

As illustrated in FIGS. 2 and 3, the dispenser body 2 has a disk section 20, a first cylindrical section 21A, a second cylindrical section 21B, a third cylindrical section 21C, a fourth cylindrical section 21D, ribs 22, a nozzle section 23, and a handle section 24. The disk section 20, the first cylindrical section 21A, the second cylindrical section 21B, the third cylindrical section 21C, and the fourth cylindrical section 21D have a common axis 200. Hereinafter, in a direction along the axis 200, the side of the disk section 20 is also referred to as “top” with respect to the first cylindrical section 21A and the side of the first cylindrical section 21A is also referred to as “bottom” with respect to the disk section 20. However, the terms “top” and “bottom” refer to the relative positional relationship in the dispenser 1, and do not necessarily mean the “top” and the “bottom” in the vertical direction.

The disk section 20 has a shallow dish shape and has a circular shape as viewed from the vertical direction. The disk section 20 has a tubular section 20A having a bottomed cylindrical shape on the outer edge side at the lower surface. The axis of the tubular section 20A extends in the radial direction of the disk section 20.

The first cylindrical section 21A has a bottomed cylindrical shape and projects from the lower surface of the disk section 20. The suction port 10 is positioned at a bottom portion of the lower end of the first cylindrical section 21A. The second cylindrical section 21B has a cylindrical shape and projects from the bottom portion of the lower end of the first cylindrical section 21A. The second cylindrical section 21B surrounds the suction port 10. The suction pipe 110 can be connected to the second cylindrical section 21B. The third cylindrical section 21C has a cylindrical shape and extends downward from the outer edge of the disk section 20. The fourth cylindrical section 21D has a cylindrical shape and projects from the lower surface of the disk section 20. The fourth cylindrical section 21D surrounds the first cylindrical section 21A. The fourth cylindrical section 21D functions as an attachment section to which the container 100 is attached. A threaded portion 211 is formed on the inner surface of the fourth cylindrical section 21D. A user inserts a mouth/neck section 101 of the container 100 into a gap between the outer surface of the first cylindrical section 21A and the inner surface of the fourth cylindrical section 21D and turns the same, thereby screwing a threaded portion of the mouth/neck section 101 into the threaded portion 211 of the fourth cylindrical section 21D. This enables the container 100 to be fastened/fixed and mounted to the dispenser 1.

Two ribs 22 are provided across the axis 200. Each rib 22 has a plate shape expanding along the axis 200 and extends in a substantially radial direction of the disk section 20. In detail, each rib 22 extends in a direction connecting the nozzle section 23 and the handle section 24. Each rib 22 has a first portion 221, a second portion 222, and a third portion 223. The first portion 221 projects from the lower surface of the disk section 20 and is connected to the third cylindrical section 21C. The second portion 222 is connected to the first portion 221 and projects outward in the radial direction of the disk section 20 from the outer edge of the disk section 20 as illustrated in FIG. 4. A depression 224 is provided on the tip side of the second portion 222. The depression 224 is opened to the lower end of the second portion 222. The upper ends of the second portions 222 of each rib 22 is connected to each other through a plate-like reinforcing section 225. The third portion 223 is connected to the first portion 221 and projects outward in the radial direction of the disk section 20 from the outer edge of the disk section 20. The third portion 223 extends along the lower surface of the handle section 24 and reinforces the handle section 24. As illustrated in FIG. 1, the shape in side view of the third portion 223 as viewed from a direction orthogonal to the axis 200 is a curved shape depressed upward and follows a user's finger.

The nozzle section 23 is connected to one axial end of the tubular section 20A of the disk section 20, projects from the outer edge of the disk section 20, and extends in the radial direction of the disk section 20 coaxially with the tubular section 20A. The nozzle section 23 has a cylindrical shape having a diameter larger than that of the tubular section 20A. The nozzle section 23 is interposed between the second portions 222 of the ribs 22. At the tip of the nozzle section 23, a cap 23A is installed. The discharging opening 16 is positioned at a tip portion of the cap 23A. The cap 23A is partly combined with the second portion 222 of each rib 22 and closes the opening of the depression 224, thereby forming a support hole.

The handle section 24 has a plate shape and projects from the opposite side to the nozzle section 23 across the axis 200 of the outer edge of the disk section 20. The handle section 24 is located on the opposite side to the discharging opening 16 across the axis 200 of the disk section 20. As illustrated in FIGS. 1 and 4, the handle section 24 has a first portion 241 extending in the radial direction of the disk section 20 and a second portion 242 bent with respect to the first portion 241 and extending downward. The second portion 242 extends away from the axis 200 toward the lower side.

Hereinafter, the internal structure of the dispenser body 2 is described. As illustrated in FIGS. 2 and 3, the dispenser body 2 has a depression 25, a biasing unit containing hole 26, a suction valve containing hole 27, an annular groove 28, a first tubular hole 291, a second tubular hole 292, and a third tubular hole 293.

The depression 25 is formed in the disk section 20 and opened to the upper side of the disk section 20. The depression 25 is depressed in the shape of a watch glass. A bottom surface 250 of the depression 25 has a curved surface shape in which the spherical surface is partly cut out, for example. The bottom surface 250 has a circular shape in plan as viewed from above but may have an oval shape or the like.

The biasing unit containing hole 26 is formed inside the disk section 20 and the first cylindrical section 21A. The biasing unit containing hole 26 has a cylindrical shape and one axial end opened to the bottom surface 250 of the depression 25. This opening functions as an inlet to the pump chamber 11.

The suction valve containing hole 27 is formed inside the first cylindrical section 21A and connected to the other axial end of the biasing unit containing hole 26. The suction valve containing hole 27 has a cylindrical shape having a diameter smaller than that of the biasing unit containing hole 26 and is partitioned by the bottom portion of the lower end of the first cylindrical section 21A. The suction port 10 formed in the bottom portion of the first cylindrical section 21A is connected to the suction valve containing hole 27, thereby making the suction port 10 and the depression 25 communicate with each other. More specifically, a passage connected to the depression 25 through the suction valve containing hole 27 and the biasing unit containing hole 26 from the suction port 10 functions as a suction passage of the liquid material to the pump chamber 11.

The depression 25, the biasing unit containing hole 26, the suction valve containing hole 27, and the suction port 10 have a common axis and extend along this axis. In this embodiment, this axis is aligned with the axis 200 of the disk section 20 and the like.

The annular groove 28 is an annular groove surrounding an opening of the depression 25 on the upper side of the disk section 20, formed by an inner wall 28A, a bottom portion 28B, and an outer wall 28C, and opened upward. The bottom portion 28B has a planar shape expanding in the direction orthogonal to the axis 200. The inner wall 28A and the outer wall 28C have a cylindrical shape extending in the direction along the axis 200. The inner wall 28A is provided with a step portion 281 at the upper end of the outer periphery. The outer wall 28C is provided with a step portion 282 at the upper end of the inner periphery. An upper side portion of the inner wall 28A also serves as the outer wall of the depression 25. As illustrated in FIGS. 2, 4 and 5, the inner wall 28A is provided with a cutout 280 on the side of the handle section 24. The disk section 20 is provided with an inclined surface 206 at a position corresponding to the cutout 280 of the outer edge of the depression 25. The inclined surface 206 traverses the inner wall 28A and connects the bottom surface 250 of the depression 25 and the outer periphery of the inner wall 28A. The inclined surface 206 is gradually directed downward toward the outside in the radial direction of the disk section 20 and approaches the bottom portion 28B of the annular groove 28.

The first tubular hole 291, the second tubular hole 292, and the third tubular hole 293 have a cylindrical shape and have a common axis extending in the radial direction of the disk section 20 or the depression 25. The first tubular hole 291, the second tubular hole 292, and the third tubular hole 293 increase in the diameter in this order and are directed from the inside to the outside in the radial direction of the depression 25 in this order. The first tubular hole 291 is formed inside the tubular section 20A of the disk section 20. The second tubular hole 292 and the third tubular hole 293 are formed inside the nozzle section 23. One axial end of the first tubular hole 291 is located on the side close to the axis 200 of the disk section 20 and the like and closed. The other axial end of the first tubular hole 291 is located on the side far from the axis 200. An upper section on the other axial end side of the first tubular hole 291 intersects the annular groove 28 and is connected to the annular groove 28. One axial end of the second tubular hole 292 is located on the side close to the axis 200 and connected to the other axial end of the first tubular hole 291 through a truncated cone-like valve seat 294. The other axial end of the second tubular hole 292 is located on the side far from the axis 200 and connected to one axial end of the third tubular hole 293 through a truncated cone-like step. To the other axial end of the third tubular hole 293, a portion in which the discharging opening 16 is formed of the cap 23A is fitted.

The elastic member 3 is installed on the upper side of the disk section 20. The elastic member 3 is formed using a synthetic resin, for example, as a material and has flexibility. The elastic member 3 has a lid section 30, a flange portion 31, and an annular projection 32.

The lid section 30 is an elastically deformable membranous portion and has predetermined elasticity. The lid section 30 covers the opening of the depression 25 and forms the pump chamber 11 together with the depression 25. The axis 200 of the depression 25 and the like serves as the central axis of the pump chamber 11. In an initial state before the lid section 30 is deformed, the lid section 30 has a dome shape expanding upward with respect to the opening of the depression 25, i.e., the side away from the bottom surface 250 of the depression 25, and has a curved surface shape in which the spherical surface is partly cut out, for example. The lid section 30 has a circular shape in plan view as viewed from above but may have an oval shape or the like.

The flange portion 31 is an annular connection portion surrounding the outer periphery of the lid section 30. The flange portion 31 has a plate shape expanding in the direction orthogonal to the axis 200.

The annular projection 32 has an annular shape surrounding the outer periphery of the lid section 30 and has a cylindrical shape projecting from the lower surface of the flange portion 31. The annular projection 32 enters the annular groove 28, so that the flange portion 31 can be fitted to the step portion 281 of the inner wall 28A and the step portion 282 of the outer wall 28C of the annular groove 28. Thus, the flange portion 31 closes an opening of the annular groove 28 and the elastic member 3 closes the opening of the depression 25. The outer periphery of the annular projection 32 contacts the inner periphery of the outer wall 28C of the annular groove 28. In other words, the annular projection 32 is fitted to the outer wall 28C. This increases the bonding degree of the elastic member 3 to the disk section 20 and improves the liquid tightness of the pump chamber 11.

The suction valve 4 is a disc valve formed of a synthetic resin and installed in the suction valve containing hole 27. The suction valve 4 integrally has a valve body, a return spring, and a base. The base is a cylindrical portion and arranged facing the inner peripheral surface of the suction valve containing hole 27. The valve body is a disc-shaped portion and arranged inside the base. The return spring is a linear portion extending along the inner periphery of the base and has one end connected to the base and the other end connected to the valve body. Two or more (e.g., three) of the return springs are provided side by side in the circumferential direction of the base. The valve body of the suction valve 4 is installed at the bottom portion of the lower end of the first cylindrical section 21A to close the suction port 10. When the pressure inside the first cylindrical section 21A becomes lower than the pressure inside the second cylindrical section 21B and the thrust due to a pressure difference between them exceeds a biasing force of the above-described return springs, the valve body is separated from the above-described bottom portion of the first cylindrical section 21A and the suction port 10 is opened. When the pressure inside the first cylindrical section 21A rises and the thrust due to the above-described pressure difference falls below the biasing force of the above-described return springs, the valve body contacts the above-described bottom portion of the first cylindrical section 21A and the suction port 10 is closed. When the pressure inside the first cylindrical section 21A is equal to or higher than the pressure inside the second cylindrical section 21B, the above-described state in which the suction port 10 is closed is maintained.

As illustrated in FIG. 2, the discharge valve 5 is a ball valve and contained in the second tubular hole 292 and the third tubular hole 293. The discharge valve 5 has a ball-shaped valve body 50 and a return spring 51. The diameter of the valve body 50 is slightly smaller than the diameter of the second tubular hole 292. A gap between the second tubular hole 292 and the valve body 50 can be set to such a size that the flow of the liquid material in the gap is suppressed and the movement of the valve body 50 with respect to the second tubular hole 292 is not hindered, for example. The valve body 50 is contained in the second tubular hole 292 and seated on the valve seat 294, thereby closing between the first tubular hole 291 and the second tubular hole 292. The return spring 51 is a coil spring and installed in a pressed and contracted state between the cap 23A and the valve body 50 and normally biases the valve body 50 toward the valve seat 294. When the thrust due to the pressure on the side of the first tubular hole 291 exceeds the total of the thrust due to the pressure on the side of the second tubular hole 292 and the biasing force of the return spring 51, the valve body 50 of the discharge valve 5 is separated from the valve seat 294 and further moves from the second tubular hole 292 to the third tubular hole 293. This substantially opens the discharge valve 5. The liquid material from the first tubular hole 291 can be discharged from the discharging opening 16 through a gap between the third tubular hole 293 and the valve body 50.

The pressing member 7 is arranged on the opposite side to the pump chamber 11 across the lid section 30, facing the upper surface of the lid section 30. The pressing member 7 is provided integrally with a lever 71 and molded integrally with the lever 71 using a synthetic resin, for example, as a material. The lever 71 has a plate shape gently curved and projecting upward. As illustrated in FIG. 1, the lever 71 has hinge portions 71A and a holding section 71B. The hinge portions 71A are located at one longitudinal end of the lever 71. The holding section 71B is located at the other longitudinal end of the lever 71.

The hinge portions 71A are located on both sides of the lever 71 in the plate width direction. The hinge portions 71A have a plate shape and straddle and interpose the nozzle section 23 and the second portions 222 of the ribs 22. Support projections are provided on the surfaces facing each other of the hinge portions 71A and 71A. The support projections are turnably fitted to the support hole formed between the cap 23A and the second portions 222 of the ribs 22. The hinge portions 71A function as a fulcrum of the lever 71.

The holding section 71B faces the handle section 24 of the dispenser body 2 in the turning direction of the lever 71. In the initial position of the lever 71, there is a predetermined distance between the first portion 241 of the handle section 24 and the holding section 71B. The above-described predetermined distance is, for example, such a distance that it is easy for a user to press the holding section 71B, using one hand, with the thumb while holding the handle section 24 with the index finger or the other fingers. The holding section 71B functions as the point where a force is applied of the lever 71.

The pressing member 7 has a pressing portion 70. The pressing portion 70 is provided between the hinge portions 71A and the holding section 71B in the lever 71 and projects from the lower surface of the lever 71. The pressing portion 70 faces the lid section 30 in the turning direction of the lever 71. As illustrated in FIGS. 1 and 3, the pressing portion 70 includes a plurality (e.g., seven) of plate portions 701. Each plate portion 701 has a plate shape perpendicularly expanding with respect to the lower surface of the lever 71 and extends in the longitudinal direction of the lever 71. Some of the plate portions 701 are connected to the hinge portions 71A. An imaginary envelope surface passing through the tip of each plate portion 701 in common can be assumed. This envelope surface is a curved surface in which the spherical surface is partly cut out, for example. At least a part of the above-described envelope surface has a shape along the bottom surface 250 of the depression 25 and has a curvature equal to that of the bottom surface 250, for example.

As illustrated in FIG. 2, the biasing unit 8 has a first support member 81, a second support member 82, and a coil spring 80. The second support member 82 is fitted to the inner periphery of the first support member 81. Both the support members 81 and 82 are slidable with respect to each other. The engagement of one axial end of the first support member 81 with one axial end of the second support member 82 restrains the second support member 82 from coming out of the first support member 81, thereby defining the maximum axial dimension of the biasing unit 8. The coil spring 80 is installed in a normally pressed and contracted state between a flange portion at the other axial end of the first support member 81 and a flange portion at the other axial end of the second support member 82. In the initial state, the axial dimension of the biasing unit 8 is maximum. The second support member 82 is installed in the biasing unit containing hole 26. The above-described flange portion of the first support member 81 faces the lid section 30 and can contact the lid section 30.

As illustrated in FIGS. 2 and 3, a pathway is formed between the annular groove 28 and the inner surface of the elastic member 3. Specifically, an annular space surrounded by the annular groove 28, the flange portion 31, and the annular projection 32 functions as a first passage 13 communicating with the pump chamber 11. The first passage 13 is provided outside the pump chamber 11 in the radial direction of the depression 25. In other words, the first passage 13 is located on the radially outside of the depression 25 relative to the pump chamber 11 as viewed in the direction along the axis 200 of the disk section 20. As illustrated in FIG. 2, a space surrounded by the inner surface of the elastic member 3, the inclined surface 206 of the disk section 20, and the cutout 280 of the inner wall 28A of the annular groove 28 functions as a first communication port 12 which is a site where the pump chamber 11 and the first passage 13 communicate with each other. The first communication port 12 is positioned on the opposite side to the discharging opening 16 across the central axis of the pump chamber 11. Specifically, the first communication port 12 is positioned in a region on the side opposite to the side of the discharging opening 16 with respect to the axis 200 in the pump chamber 11. The first communication port 12 is provided at the outer edge of the pump chamber 11 in the direction orthogonal to the axis 200, in other words, in the radial direction of the depression 25. As viewed in the direction along the axis 200, the first communication port 12 is positioned on a straight line connecting the axis 200 and the discharging opening 16. The first communication port 12 is located at a position where the distance from the discharging opening 16 in the radial direction of the depression 25 is the largest of the outer edge of the pump chamber 11.

Meanwhile, the first tubular hole 291, the second tubular hole 292, and the third tubular hole 293 function as a second passage 15 communicating with the discharging opening 16. An intersection portion between the first tubular hole 291 and the annular groove 28 functions as a second communication port 14 which is a site where the first passage 13 and the second passage 15 communicate with each other. The second communication port 14 and the discharging opening 16 are positioned on the same side with respect to the central axis of the pump chamber 11. Specifically, the second communication port 14 is positioned in a region on the same side as the discharging opening 16 with respect to the axis 200 in the pump chamber 11. The second communication port 14 is provided at the outer edge of the pump chamber 11 in the direction orthogonal to the axis 200, in other words, in the radial direction of the depression 25. As viewed in the direction along the axis 200, the second communication port 14 is positioned on the straight line connecting the axis 200 and the discharging opening 16. The second communication port 14 is located at a position where the distance from the discharging opening 16 in the radial direction of the depression 25 is the smallest of the outer edge of the pump chamber 11.

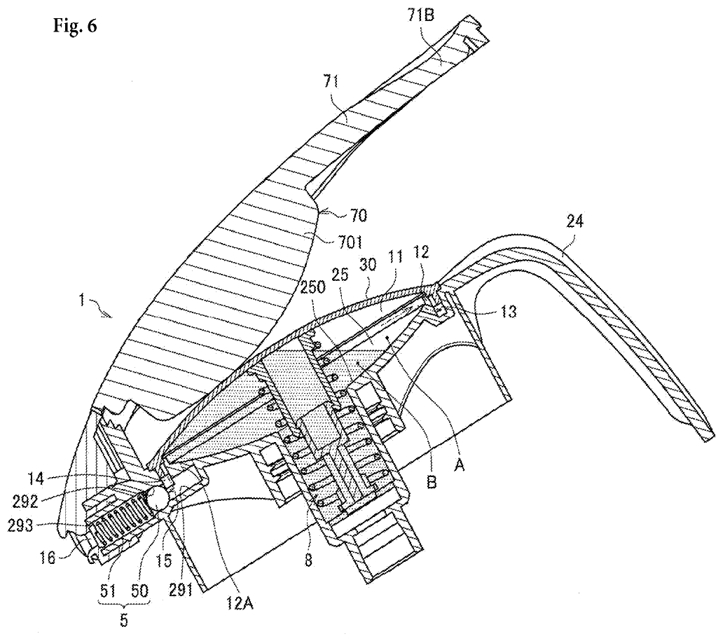

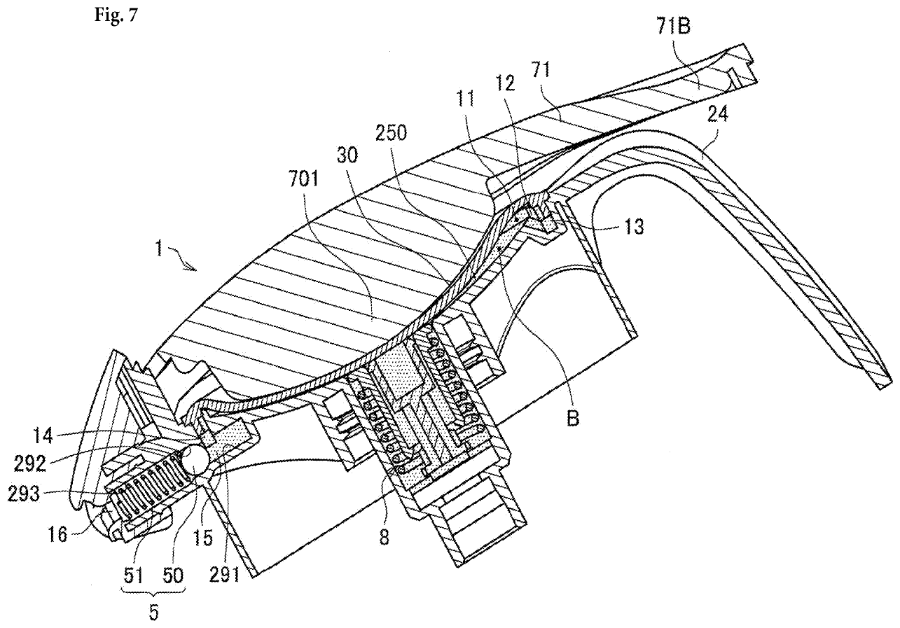

Next, the action and advantages of the dispenser 1 are described. FIGS. 6 and 7 are cross-sectional views similar to FIG. 2. FIG. 6 illustrates a state (initial state) before the dispenser 1 acts by pressing-down of the lever 71 by a user. FIG. 7 illustrates a state (maximum stroke state) in which a user presses down the lever 71 to the lowest side.

As illustrated in FIG. 6, when a user holds the handle section 24 to extract a liquid material B, the dispenser 1 tends to be tilted together with the container 100 such that the discharging opening 16 is positioned on the vertically lower side relative to the handle section 24. When air A remains in the pump chamber 11, the air A is positioned on the vertically upper side relative to the liquid material B. When the user presses down the holding section 71B of the lever 71 with the thumb of the hand holding the handle section 24, the pressing portion 70 functions as the point of action of the lever 71 and presses the lid section 30 downward. The pressing portion 70 presses the lid section 30 for elastic deformation to the side toward the bottom surface 250 of the depression 25, i.e., to the side where the volume of the pump chamber 11 decreases. The plurality of plate portions 701 functions as a single projection with the envelope surface thereof being the tip surface. The lid section 30 is deformed into a shape following the above-described envelope surface, i.e., a curved surface shape projecting toward the inside of the pump chamber 11. When the lid section 30 is deformed, reducing the volume of the pump chamber 11, the pressure inside the pump chamber 11 becomes higher than the external pressure, e.g., atmospheric pressure. This closes the suction valve 4 and opens the discharge valve 5.

As illustrated by alternate long and short dashed line arrows in FIGS. 5 and 6, the contents of the pump chamber 11, i.e., the air A and the liquid material B, flow out of the pump chamber 11 into the first passage 13 through the first communication port 12 and flow out of the first passage 13 into the second passage 15 through the second communication port 14 to be discharged from the discharging opening 16. The first communication port 12 functions as an outlet from the pump chamber 11 to the first passage 13. The second communication port 14 functions as an outlet from the first passage 13 to the second passage 15. The first passage 13 and the second passage 15 are provided to make the first communication port 12 as an outlet provided in the pump chamber 11 and the discharging opening 16 communicable with each other and function as pathways allowing the air A and the liquid material B to flow from the pump chamber 11 to the discharging opening 16. The first communication port 12 is positioned on the opposite side to the discharging opening 16 across the central axis of the pump chamber 11. Therefore, when the dispenser 1 is tilted such that the discharging opening 16 is positioned on the vertically lower side as illustrated in FIG. 6, the first communication port 12 is positioned on the vertically upper side. Therefore, the air A positioned on the vertically upper side relative to the liquid material B in the pump chamber 11 flows out of the pump chamber 11 through the first communication port 12 to be discharged from the discharging opening 16 before the liquid material B. When most of the air A flows out of the pump chamber 11 and the liquid level of the liquid material B reaches the first communication port 12, the liquid material B then flows out of the pump chamber 11 through the first communication port 12 to be discharged from the discharging opening 16. The user can adjust the discharge amount of the liquid material B as appropriate by adjusting the pressing-down amount of the lever 71.

As illustrated in FIG. 7, when the pressing portion 70 is pressed down to a position where the lid section 30 is positioned along the bottom surface 250 of the depression 25, a further displacement of the lever 71 is suppressed. The position of the pressing member 7 at this time is the maximum stroke position. A stopper may be separately provided to regulate the upper limit of the displacement of the lever 71. At the maximum stroke position, a gap between the lid section 30 and the bottom surface 250 of the depression 25 is minimized. The volume reduction amount from the initial state of the pump chamber 11, i.e., the discharge amount of the contents of the pump chamber 11, is maximized.

When a user weakens a force for pressing down the holding section 71B of the lever 71, the lid section 30 tends to return to the initial state by an elastic force thereof and the biasing unit 8 biases the lid section 30 toward the initial position, and therefore the pressing member 7 is returned to the initial position. The pressing portion 70 is displaced upward and the lid section 30 is elastically deformed toward the initial state, thereby increasing the volume of the pump chamber 11. The pressure inside the pump chamber 11 becomes lower than the external pressure. This closes the discharge valve 5 and opens the suction valve 4. The liquid material B is sucked into the pump chamber 11 from the container 100 through the suction passage.

With respect to the discharge valve 5, when the total of the thrust due to the pressure on the side of the third tubular hole 293 and the biasing force of the return spring 51 exceeds the thrust due to the pressure on the side of the second tubular hole 292, the valve body 50 moves from the third tubular hole 293 to the second tubular hole 292. This substantially closes the discharge valve 5. During when the valve body 50 moves toward the valve seat 294 inside the second tubular hole 292, the flow of the liquid material B through the gap between the second tubular hole 292 and the valve body 50 is suppressed. Accordingly, the liquid material B inside the third tubular hole 293 is drawn into the second tubular hole 292 together with the above-described movement of the valve body 50, and thus the leakage (liquid dripping) of the liquid material B from the discharging opening 16 to the outside can be suppressed.

Due to the fact that the dispenser 1 is provided with the pressing member 7, the lid section 30 can be efficiently elastically deformed to increase the amount of the liquid material B which can be discharged from the pump chamber 11. Due to the fact that the pressing member 7 is provided with the lever 71, an operation force of a user is amplified, and therefore the amount of the liquid material B which can be discharged from the pump chamber 11 can be increased with a small operation force. The dispenser 1 may not be provided with the lever 71 or the pressing member 7.

As described above, the first communication port 12 as the outlet provided in the pump chamber 11 is positioned on the opposite side to the discharging opening 16 across the central axis of the pump chamber 11. In other words, as viewed from the movement direction (e.g., the direction along the axis 200) of the lid section 30 as a movable member changing the volume of the pump chamber 11, the first communication port 12 is positioned on the opposite side to the discharging opening 16 across a center portion of the pump chamber 11. Alternatively, the first communication port 12 is positioned on the opposite side to the discharging opening 16 across a center portion (axis 200) of the bottom surface 250 of the depression 25, which is the surface facing the lid section 30 as a movable member, of the surface of the dispenser body 2 as an immovable member constituting the inner surface of the pump chamber 11. Thus, the first communication port 12 is positioned on the opposite side to the discharging opening 16 across the center portion of the pump chamber 11. Accordingly, the air release from the pump chamber 11 is promoted, and therefore the air releasability can be improved and the usability of the dispenser 1 can be improved.

More specifically, when the air A remains inside the pump chamber 11, there is a risk that the liquid material B vigorously spills out of the discharging opening 16 in the form of bubbles and is scattered. Further, when the air A remains inside the pump chamber 11, the amount of a stroke to contract the pump chamber 11 increases, so that there is a risk that the extraction amount of the liquid material B in a single extraction operation by the dispenser 1 decreases. These can reduce the usability of the dispenser 1. In contrast, when the air A inside the pump chamber 11 is moved to a position overlapping the outlet provided in the pump chamber 11 and the pump chamber 11 is contracted in this state, the air release can be achieved. However, it is usually rare for a user to intentionally release the air from the pump chamber 11. This is because it is difficult for a user to know in advance the position of the above-described outlet in the pump chamber 11. When installing the outlet in the pump chamber 11, it is usual for a person skilled in the art to position the above-described outlet on the same side as the discharging opening 16 in the pump chamber 11, in other words, on the same side as the discharging opening 16 with respect to the central axis of the pump chamber 11, as illustrated by a dashed line 12A in FIG. 6, for example. One of the reasons therefor is that this can shorten the pathway from the outlet positioned on the dashed line 12A to the discharging opening 16. Meanwhile, when the dispenser 1 is used, the dispenser 1 tends to be tilted such that the discharging opening 16 is positioned on the vertically lower side as described above. In this case, the air A inside the pump chamber 11 stays on the vertically upper side, i.e., on the opposite side to the discharging opening 16, as illustrated in FIG. 6. This makes it difficult to make the air A inside the pump chamber 11 overlap the outlet positioned on the dashed line 12A. A user cannot release the air without intentionally facing the discharging opening 16 vertically upward.

In contrast, in the dispenser 1 of this embodiment, the first communication port 12 as the outlet provided in the pump chamber 11 is positioned on the opposite side to the discharging opening 16 across the central axis of the pump chamber 11. Accordingly, even when the air A remains inside the pump chamber 11 in any use, the first communication port 12 is relatively positioned on the vertically upper side as with the air A simply by tilting the dispenser 1 by a user such that the discharging opening 16 is relatively positioned on the vertically lower side. Therefore, the air A can be discharged from the discharging opening 16 from the first communication port 12 through the first passage 13 and the second passage 15 before the liquid material B. This allows the air release to be automatically performed without a user being aware of it. The air release from the pump chamber 11 is naturally promoted as described above, and therefore the air releasability can be improved and the usability of the dispenser 1 can be improved. For example, after the air release is performed as described above at the start of use, the inside of the pump chamber 11 is filled with the liquid material B, which suppresses the liquid material B from spilling out in the form of bubbles from the discharging opening 16 during the extraction operation. Further, the reduction in the extraction amount in the single extraction operation is suppressed.

The dispenser 1 may include the handle section 24 provided on the opposite side to the discharging opening 16 across the central axis of the pump chamber 11. In this case, when a user holds the handle section 24 and uses the dispenser 1, the discharging opening 16 tends to be positioned on the vertically lower side and the air A tends to stay on the opposite side to the discharging opening 16. Accordingly, the air release from the pump chamber 11 can be effectively promoted. The handle section 24 provided on the opposite side to the discharging opening 16 across the central axis of the pump chamber 11 may be provided on the side of the container 100, for example, without being limited to the dispenser 1. The dispenser 1 or the container 100 may not be provided with the handle section 24.

The first communication port 12 as the outlet provided in the pump chamber 11 may be positioned on the diametrically opposite side to the discharging opening 16 across the central axis of the pump chamber 11. For example, the first communication port 12 may be positioned on the straight line connecting the axis 200 and the discharging opening 16 as viewed in the direction along the axis 200. In this case, when the dispenser 1 is tilted such that the discharging opening 16 is positioned on the vertically lower side, the air A gathering to the vertically upper side inside the pump chamber 11 easily overlaps the first communication port 12, and therefore the air release can be effectively promoted. The first communication port 12 may not be positioned on the diametrically opposite side to the discharging opening 16 across the central axis of the pump chamber 11. For example, as illustrated in FIG. 5, a straight line 201 is assumed which is orthogonal to the straight line connecting the discharging opening 16 and the axis 200 and passes through the axis 200 as viewed in the direction along the axis 200. When the first communication port 12 is positioned at an arbitrary site on the side of the handle section 24 relative to the straight line 201 in the pump chamber 11, the first communication port 12 is relatively positioned on the vertically upper side when the dispenser 1 is tilted such that the discharging opening 16 is positioned on the vertically lower side or when the dispenser 1 is tilted such that the handle section 24 is positioned on the vertically upper side. Therefore, the air inside the pump chamber 11 can be easily made to overlap the first communication port 12. More specifically, the description “positioned on the opposite side to the discharging opening 16 across the central axis of the pump chamber 11” in the present disclosure means being positioned on the side of a region where the discharging opening 16 is not present when two regions are divided with the straight line 201 illustrated in FIG. 5 as a reference, for example.

The number of the outlets provided in the pump chamber 11 is not limited to one, and the dispenser 1 may include a plurality of the above-described outlets. In this case, no matter how the dispenser 1 is tilted, the air gathering to the vertically upper side inside the pump chamber 11 easily overlaps one of the plurality of outlets, and therefore the air release can be more reliably promoted.

The dispenser 1 may include two or more of the pathways from the pump chamber 11 to the discharging opening 16. For example, as illustrated by the alternate long and short dashed line arrows in FIG. 5, the liquid material flowing out of the first communication port 12 toward the first passage 13 can move to the second communication port 14 through two pathways, one in a clockwise direction and the other in a counterclockwise direction with respect to the axis 200. Due to the fact that the plurality of pathways is provided as described above, the flow path cross-sectional area of the pathways as a whole can be increased and an increase in the flow path resistance can be suppressed. Accordingly, an operation force required to extract the liquid material from the dispenser 1 can be reduced. Further, the flow path cross-sectional area of one pathway can be reduced or the flow path of the pathway can be lengthened, and therefore the degree of freedom of layout of the pathway can be improved.

The dispenser body 2 may have the depression 25 and the dispenser 1 may have the lid section 30. The lid section 30 is elastically deformable, covers the depression 25, and forms the pump chamber 11 together with the depression 25. When the pump chamber 11 is formed by the lid section 30 as described above, the diameter of the pump chamber 11 can be increased. Therefore, the amount of the liquid material which can be extracted by a single operation can be increased while suppressing the enlargement of the dispenser 1 in the direction along the axis 200 of the depression 25. The bottom surface 250 of the depression 25 may have a circular shape or an oval shape in plan view. In this case, the volume of the pump chamber 11 can be more efficiently increased. The depression 25 may be depressed in the shape of a watch glass. In this case, when the lid section 30 is deformed, the gap between the lid section 30 and the bottom surface 250 of the depression 25 can be made as small as possible and the amount of the liquid material which can be extracted from the pump chamber 11 can be effectively increased. In the structure in which the elastically deformable lid section 30 is used as a member for forming the pump chamber 11 as described above, the diameter of the pump chamber 11 becomes relatively large as described above, and therefore, when the dispenser 1 is tilted, the air inside the pump chamber 11 can greatly move to the radially outside of the depression 25. Hence, when the position of the outlet provided in the pump chamber 11 is not properly considered, the above-described air tends to gather at a position off the above-described outlet. In the dispenser 1 having such a structure, the first communication port 12 as the outlet provided in the pump chamber 11 is positioned on the opposite side to the discharging opening 16 across the central axis of the pump chamber 11, and therefore, when the dispenser 1 is tilted, the position where the air inside the pump chamber 11 gathers is easily made to overlap the first communication port 12 in this embodiment. More specifically, the air release from the pump chamber 11 can be promoted. The lid section 30 may have a dome shape bulging out to the side opposite to the side of the depression 25. More specifically, the pump chamber 11 of the dispenser 1 may be a so-called dome-shaped pump. Thus, the amount of the liquid material which can be extracted by a single operation can be more effectively increased while suppressing the enlargement of the dispenser 1. The form of the pump chamber 11 is not limited to the dome-shaped pump, and the elastically deformable lid section 30 may not bulge out to the side opposite to the side of the depression 25. The dispenser 1 may be a pump type, and the member for changing the volume of the pump chamber 11 is not limited to the elastically deformable lid section 30 and may be a piston or the like.

The first communication port 12 as the outlet provided in the pump chamber 11 may be provided at the outer edge of the pump chamber 11 in the radial direction of the depression 25. In this case, the first communication port 12 is more easily positioned on the vertically upper side when the dispenser 1 is used in a tilted manner as compared with a case where the above-described outlet is positioned on the radially inside of the depression 25 relative to the outer edge of the pump chamber 11. Accordingly, the air staying on the vertically upper side in the pump chamber 11 easily overlaps the first communication port 12 and is easily discharged from the first communication port 12. Further, even when the amount of the air inside the pump chamber 11 decreases due to the discharge, the air easily overlaps the first communication port 12 and is easily discharged from the first communication port 12 until the end.

The first passage 13 and the second passage 15 as the pathways from the pump chamber 11 to the discharging opening 16 may be provided outside the pump chamber 11 in the radial direction of the depression 25. In other words, the first passage 13, for example, of the above-described pathways may be provided on the radially outside relative to the depression 25. In this case, the superimposition of the pump chamber 11 and the above-described pathway as viewed in the direction along the axis 200, in other words, in the radial direction of the depression 25, is suppressed. Therefore, when the above-described pathways are located inside the pump chamber 11 in the radial direction of the depression 25 and superimposed on the pump chamber 11, an increase in the dimension of the dispenser 1 in the direction along the axis 200 can be suppressed as compared with a case where the above-described pathways are provided below a bottom portion of the depression 25, for example. In other words, a reduction in the size in the axial direction of the dispenser 1 can be achieved while maintaining the volume of the pump chamber 11.

The annular groove 28 surrounding the depression 25 is provided on the side to which the lid section 30 is attached in the dispenser body 2. The annular groove 28 may form the first passage 13 as a pathway from the pump chamber 11 to the discharging opening 16. In this case, one side, i.e., the upper side, of the annular groove 28 is in an opened state. However, by attaching the elastic member 3 including the lid section 30 to the dispenser body 2, the annular groove 28 can function as the above-described pathway isolated from the inside of the pump and the outside of the dispenser 1. In other words, the elastic member 3 can also serve as the wall of the first passage 13. Therefore, an increase in the number of parts can be suppressed. Since it is sufficient to form the annular groove 28 in the dispenser body 2 to provide the first passage 13, molding is facilitated and the mold structure of the dispenser body 2 can be simplified. Further, it becomes easy to provide the above-described pathway outside the pump chamber 11 in the radial direction of the depression 25.

The inner wall 28A of the annular groove 28 may also serve as the wall of the pump chamber 11. In this case, the dispenser 1 can be suppressed from being enlarged in the radial direction of the depression 25. Due to the fact that the cutout 280 is provided in the inner wall 28A, the first communication port 12 as the outlet provided in the pump chamber 11 can be formed, and therefore it is easy to provide the above-described outlet at the outer edge of the pump chamber 11.

The dispenser 1 may further include a projection engageable with the annular groove 28 on the outer periphery of the lid section 30. For example, the annular projection 32 provided on the outer periphery of the elastic member 3 can function as the above-described projection. In this case, the assemblability of the elastic member 3 to the dispenser body 2 can be improved. The contact of the above-described projection with the annular groove 28 facilitates the isolation of the first passage 13 as a pathway from the pump chamber 11 to the discharging opening 16 from the inside of the pump chamber 11 or the outside of the dispenser 1. For example, the contact of the annular projection 32 with the outer wall 28C of the annular groove 28 enables the isolation of the first passage 13 from the outside of the dispenser 1. The above-described projection may contact the inner wall 28A of the annular groove 28. In this case, the first passage 13 as the above-described pathway can be isolated from the inside of the dispenser 1, e.g., the pump chamber 11.

The above-described projection engageable with the annular groove 28 may have an annular shape as in the annular projection 32. In this case, an increase in the contact range between the annular groove 28 and the projection 32 enables more liquid-tight isolation of the first passage 13 as the pathway from the pump chamber 11 to the discharging opening 16.

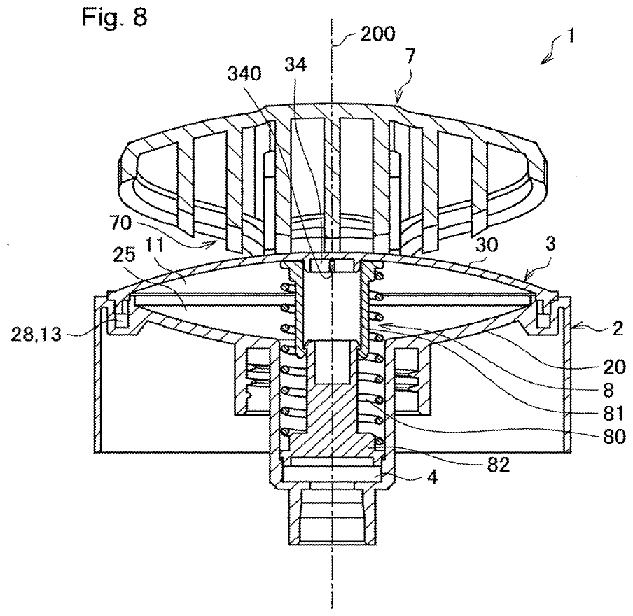

(Modification) FIG. 8 is a cross-sectional view similar to FIG. 3, illustrating a modification of the dispenser 1. As illustrated in FIG. 8, the elastic member 3 may be provided with a locking portion 34. The locking portion 34 is a cylindrical rib and projects from a center portion of the lower surface of the lid section 30. The axis of the locking portion 34 is common to the axis 200 of the disk section 20 and the like. In this case, the locking portion 34 is fitted to the inner periphery of the flange portion on the other axial end of the first support member 81, thereby restraining the movement of the first support member 81 in the radial direction of the depression 25, and therefore the action of the biasing unit 8 can be smoothened.

The locking portion 34 may be provided with a slit 340. The slit 340 is a gap extending in the axial direction of the locking portion 34. By providing the slit 340, when the lid section 30 is elastically deformed, the connection place of the locking portion 34 in the lid section 30 can be easily deformed, and therefore a reduction in the operation force can be achieved.

The slit 340 and the discharging opening 16 may be arranged on the opposite sides across the axis of the locking portion 34. For example, the straight line 201 illustrated in FIG. 5 passes through the axis of the locking portion 34 as viewed in the direction along the axis 200. When the slit 340 is positioned at an arbitrary site on the side of the first communication port 12 (opposite side to the side of the discharging opening 16) relative to the straight line 201 in the locking portion 34, the movement of the air inside the locking portion 34 to the side of the first communication port 12 through the slit 340 is facilitated when the dispenser 1 is tilted such that the discharging opening 16 is relatively positioned on the vertically lower side or when the dispenser 1 is tilted such that the handle section 24 is relatively positioned on the vertically upper side. This suppresses the air from remaining inside the locking portion 34.

The elastic member 3 may be attached such that the slit 340 and the discharging opening 16 are positioned on the diametrically opposite sides across the axis of the locking portion 34. For example, the elastic member 3 may be attached to the dispenser body 2 such that the straight line connecting the axis 200 and the discharging opening 16 and the slit 340 overlap each other as viewed in the direction along the axis 200. In this case, when the dispenser 1 is tilted such that the discharging opening 16 is relatively positioned on the vertically lower side, the air gathering to the vertically upper side inside the locking portion 34 easily overlaps the slit 340 and is easily discharged from the locking portion 34 until the end, and therefore the air release from the locking portion 34 can be effectively promoted.

Two or more of the slits 340 may be provided. For example, two slits 340 may be provided on the opposite sides across the axis of the locking portion 34. This facilitates the attachment of the elastic member 3 to the dispenser body 2 while positioning the slits 340 as described above. Further, marks for positioning the slits 340 may be provided on the outer edge side of the elastic member 3. For example, a depression or a cutout may be provided in the annular projection 32 and may be provided such that, when the depression or the like is aligned with the cutout 280 in the inner wall 28A of the annular groove 28, the slits 340 and the discharging opening 16 are positioned on the diametrically opposite sides across the axis of the locking portion 34.

### Second Embodiment

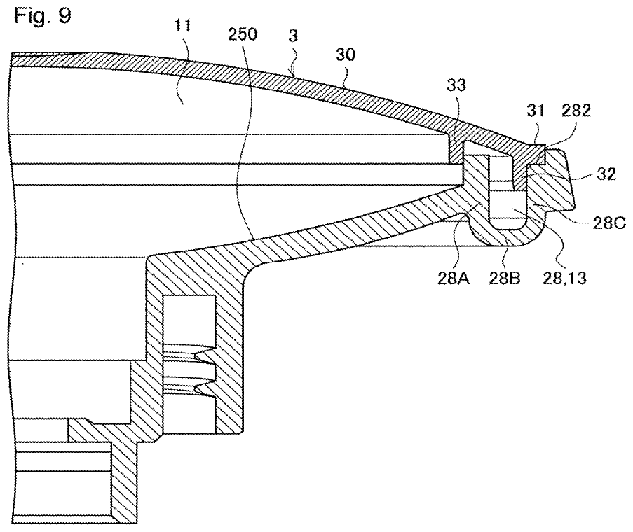

FIG. 9 is a cross-sectional view equivalent to a part of the cross-section of FIG. 3, illustrating a part of the configuration of the dispenser 1 of this embodiment. For simplicity, the illustration of the suction valve 4, the biasing unit 8, and the pressing member 7 is omitted. Hereinafter, the same signs as those of the first embodiment are attached to configurations common to those of the first embodiment, and descriptions thereof are omitted.

As illustrated in FIG. 9, the upper end of the inner wall 28A of the annular groove 28 is not provided with the step portion. The elastic member 3 has a second annular projection 33 in addition to the first annular projection 32. The second annular projection 33 is located on the radially inside relative to the first annular projection 32 and projects from the lower surface of the lid section 30. The flange portion 31 is provided only on the radially outside of the first annular projection 32 and fitted to the step portion 282 of the outer wall 28C of the annular groove 28. In the initial state before the lid section 30 is elastically deformed, the tip side of the second annular projection 33 is fitted to the inner periphery of the inner wall 28A of the annular groove 28. An annular space surrounded by the annular groove 28, the lid section 30, the first annular projection 32, and the second annular projection 33 functions as the first passage 13. Due to the fact that the outer periphery of the second annular projection 33 is in contact with the inner periphery of the inner wall 28A of the annular groove 28, the pump chamber 11 and the first passage 13 are liquid-tightly partitioned.

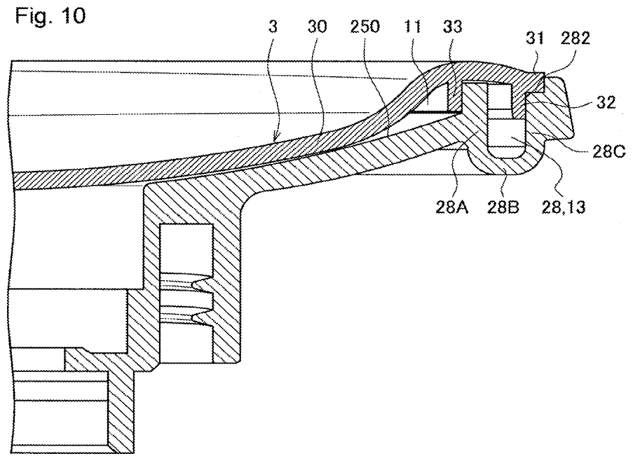

As illustrated in FIG. 10, when the lid section 30 is elastically deformed from the state of FIG. 9, the second annular projection 33 slides against the inner wall 28A of the annular groove 28, and the flow path cross-sectional area (area in the cross-section orthogonal to the alternate long and short dashed line arrows in FIG. 5) of the first passage 13 becomes smaller than that in the initial state of FIG. 8. In other words, the lid section 30 is elastically deformed such that the flow path cross-sectional area of the first passage 13 becomes larger when the volume of the pump chamber 11 is large (FIG. 9) than when the volume of the pump chamber 11 is small (FIG. 10). Accordingly, when the volume of the pump chamber 11 increases, i.e., when the suction valve 4 is opened, the discharge valve 5 is closed, and the liquid material is sucked into the pump chamber 11, the flow path cross-sectional area of the first passage 13 increases, thereby greatly reducing the pressure in the first tubular hole 291 (see FIG. 2). Thus, the valve body 50 of the discharge valve 5 is quickly returned from the third tubular hole 293 to the second tubular hole 292 and the valve body 50 is strongly sucked toward the valve seat 294 inside the second tubular hole 292. Accordingly, the leakage of the liquid material from the discharging opening 16 to the outside (liquid dripping) can be effectively suppressed.

Thus, the dispenser 1 may include the second annular projection 33 projecting from the inner surface of the lid section 30 and slidable against the inner wall 28A of the annular groove 28 in response to the elastic deformation of the lid section 30. Hence, the above-described configuration can be simply realized in which the flow path cross-sectional area of the first passage 13 changes in response to the elastic deformation of the lid section 30 while maintaining the liquid tightness between the pump chamber 11 and the first passage 13 as the pathway from the pump chamber 11. For example, the second annular projection 33 may be provided such that the outer periphery of the second annular projection 33 is in contact with the inner periphery of the inner wall 28A of the annular groove 28. In this case, the second annular projection 33 does not enter the annular groove 28, and therefore it is easy to secure a large flow path cross-sectional area of the first passage 13. It may be acceptable that the flow path cross-sectional area of the first passage 13 changes in response to the elastic deformation of the lid section 30 while liquid-tightly partitioning between the pump chamber 11 and the first passage 13 due to that fact that the second annular projection 33 enters the annular groove 28 and the inner periphery of the second annular projection 33 contacts the outer periphery of the inner wall 28A of the annular groove 28.

As described above, suitable embodiments of the present invention are described in detail with reference to the accompanying drawings but the technical scope of the present invention is not limited to such examples. It is clear that a person having ordinary knowledge in the technical field of the present invention can conceive various changes or modifications within the scope of the technical idea described in Claims, and it is naturally understood that these changes or modifications belong to the technical scope of the present invention.

With respect to the embodiments described above, the present invention further discloses the following dispensers or discharge containers.

<1>

A dispenser capable of discharging a liquid material from a discharging opening including: a pump chamber capable of sucking the liquid material; an outlet provided in the pump chamber; and a pathway provided to make the outlet and the discharging opening communicable with each other and allowing the flow of the liquid material, in which the outlet is positioned on the opposite side to the discharging opening across the central axis of the pump chamber.

<2>

The dispenser as set forth in clause <1>, in which the outlet is positioned on the diametrically opposite side to the discharging opening across the central axis of the pump chamber.

<3>

The dispenser as set forth in clause <1> or <2>, having two or more of the outlets.

<4>

The dispenser as set forth in any one of clauses <1> to <3>, having two or more of the pathways.

<5>

The dispenser as set forth in any one of clauses <1> to <4>, further having a handle section provided on the opposite side to the discharging opening across the central axis of the pump chamber.

<6>

The dispenser as set forth in any one of clauses <1> to <5>, further having a dispenser body having a depression; and an elastically deformable lid section covering the depression and forming the pump chamber together with the depression.

<7>

The dispenser as set forth in clause <6>, in which the dispenser body further has a suction port communicating with the depression, in which the liquid material is sucked into the pump chamber from the suction port.

<8>

The dispenser as set forth in clause <6> or <7>, in which the lid section has a dome shape bulging out to the side opposite to the side of the depression.

<9>

The dispenser as set forth in any one of clauses <6> to <8>, in which the depression is depressed in the shape of a watch glass.

<10>

The dispenser as set forth in any one of clauses <6> to <9>, in which the bottom surface of the depression has a circular shape or an oval shape in plan view.

<11>

The dispenser as set forth in any one of clauses <6> to <10>, in which the outlet is provided at the outer edge of the pump chamber in the radial direction of the depression.

<12>

The dispenser as set forth in any one of clauses <6> to <11>, in which the pathway is provided outside the pump chamber in the radial direction of the depression.

<13>

The dispenser as set forth in any one of clauses <6> to <12>, in which an annular groove surrounding the depression is positioned on the side to which the lid section is attached in the dispenser body and the pathway is formed by the annular groove.

<14>

The dispenser as set forth in clause <13>, further having an elastic member including the lid section and attached to the dispenser body, in which the pathway is formed by the annular groove and the elastic member.

<15>

The dispenser as set forth in clause <13> or <14>, in which the inner wall of the annular groove also serves as the wall of the pump chamber.

<16>

The dispenser as set forth in any one of clauses <13> to <15>, further having a projection engageable with the annular groove on the outer periphery of the lid section.

<17>

The dispenser as set forth in clause <16>, in which the projection engageable with the annular groove has an annular shape.

<18>

The dispenser as set forth in any one of clauses <13> to <17>, further having an annular projection projecting from the inner surface of the lid section and slidable against the inner wall of the annular groove in response to the elastic deformation of the lid section.

<19>

The dispenser as set forth in any one of clauses <6> to <18>, in which the lid section is provided to be elastically deformed such that the flow pass cross-sectional area of the pathway is larger when the volume of the pump chamber is large than when the volume of the pump chamber is small.

<20>

The dispenser as set forth in any one of clauses <6> to <19>, further having a biasing unit capable of biasing the lid section from the side of the pump chamber and a locking portion which has a tubular shape projecting from the inner surface of the lid section and with which the biasing unit is locked, in which the locking portion is provided with a slit and the slit is positioned on the opposite side to the discharging opening across the axis of the locking portion.

<21>

The dispenser as set forth in clause <20>, in which the slit is positioned on the diametrically opposite side to the discharging opening across the axis of the locking portion.

<22>

A discharge container having the dispenser as set forth in any one of clauses <1> to <21> and a container containing the liquid material.

### INDUSTRIAL APPLICABILITY

As described above, the dispenser of the present invention can improve the air releasability from the pump chamber.

1: A dispenser capable of discharging a liquid material from a discharging opening, comprising:
a pump chamber capable of sucking the liquid material;
an outlet provided in the pump chamber; and
a pathway provided to make the outlet and the discharging opening communicable with each other and allowing flow of the liquid material, wherein
the outlet is positioned on an opposite side to the discharging opening across a central axis of the pump chamber.

2: The dispenser according to claim 1, wherein the outlet is positioned on a diametrically opposite side to the discharging opening across the central axis of the pump chamber.

3: The dispenser according to claim 1, comprising:
two or more of the outlets.

4: The dispenser according to claim 1, comprising:
two or more of the pathways.

5: The dispenser according to claim 1, further comprising:
a handle section provided on the opposite side to the discharging opening across the central axis of the pump chamber.

6: The dispenser according to claim 1, further comprising:
a dispenser body having a depression; and
an elastically deformable lid section covering the depression and forming the pump chamber together with the depression.

7: The dispenser according to claim 6, wherein the dispenser body further has a suction port communicating with the depression, wherein the liquid material is sucked into the pump chamber from the suction port.

8: The dispenser according to claim 6, wherein the lid section has a dome shape bulging out to a side opposite to a side of the depression.

9. (canceled)

10: The dispenser according to claim 6, wherein a bottom surface of the depression has a circular shape or an oval shape in plan view.

11: The dispenser according to claim 6, wherein the outlet is provided at an outer edge of the pump chamber in a radial direction of the depression.

12: The dispenser according to claim 6, wherein the pathway is provided outside the pump chamber in the radial direction of the depression.

13: The dispenser according to claim 6, wherein an annular groove surrounding the depression is positioned on a side to which the lid section is attached in the dispenser body and the pathway is formed by the annular groove.

14: The dispenser according to claim 13, further comprising:
an elastic member including the lid section and attached to the dispenser body, wherein the pathway is formed by the annular groove and the elastic member.

15: The dispenser according to claim 13, wherein an inner wall of the annular groove also serves as a wall of the pump chamber.

16: The dispenser according to claim 13, further comprising:
a projection engageable with the annular groove on an outer periphery of the lid section.

17: The dispenser according to claim 16, wherein the projection engageable with the annular groove has an annular shape.

18: The dispenser according to claim 13, further comprising:
an annular projection projecting from an inner surface of the lid section and slidable against the inner wall of the annular groove in response to elastic deformation of the lid section.

19: The dispenser according to claim 6, wherein the lid section is provided to be elastically deformed such that a flow path cross-sectional area of the pathway is larger when a volume of the pump chamber is large than when the volume of the pump chamber is small.

20: The dispenser according to claim 6, further comprising:
a biasing unit capable of biasing the lid section from a side of the pump chamber and a locking portion which has a tubular shape projecting from the inner surface of the lid section and with which the biasing unit is locked, wherein
the locking portion is provided with a slit, and
the slit is positioned on an opposite side to the discharging opening across an axis of the locking portion.

21: The dispenser according to claim 20, wherein the slit is positioned on a diametrically opposite side to the discharging opening across the axis of the locking portion.

22: (canceled)
